(19) United States
(12) Patent Application Publication
(10) Pub. No.: US 2014/0280663 A1
(43) Pub. Date: Sep. 18, 2014

(54) Apparatus and Methods for Providing Performance Data of Nodes in a High Performance Computing System

(71) Applicant: SILICON GRAPHICS INTERNATIONAL CORP., Fremont, CA (US)

(72) Inventors: Dimitri George Sivanich, Bloomington, MN (US); Eric Carl Fromm, Eau Claire, WI (US); Karl Alexander Kroening, Minneapolis, MN (US)

(73) Assignee: SILICON GRAPHICS INTERNATIONAL CORP., Fremont, CA (US)

(21) Appl. No.: 13/804,532

(22) Filed: Mar. 14, 2013

(51) Int. Cl. H04L 29/08

(52) U.S. Cl. CPC H04L 29/08549
USPC 709/212

(57) ABSTRACT

In accordance with one embodiment of the invention, a method of providing performance data for nodes in a high performance computing system receives a request for performance data for a node in the high performance computing system. According to the method, a driver in kernel space causes the performance data for the node to be stored in kernel memory. The kernel memory is accessible in userspace via a first system file.

### FIELD OF THE INVENTION

The invention generally relates to providing performance data of nodes in a high performance computing system and, more particularly, the invention relates to configuring components of the system to output performance data to system files accessible in user space.

### BACKGROUND OF THE INVENTION

Performance data for a node may be stored on the node itself. Applications must interface to software operating the nodes to access the data, and the data is often output to device files.

### SUMMARY OF VARIOUS EMBODIMENTS

In accordance with one embodiment of the invention, a method of providing performance data for nodes in a high performance computing system receives a request for performance data for a node in the high performance computing system. The request is stored in kernel memory. According to the method, a driver in kernel space causes the performance data for the node to be stored in a first system file in the kernel memory. The first system file is accessible in user space.

In some embodiments, the method receives an identifier of the node in a second system file. The second system file is configured to enable communication with the driver in kernel space. According to the method, a script may write the identifier of the node to the second system file. Alternatively, the identifier of the node may be written to the second system file in response to an instruction received through a command line interface. Further, the method may cause the performance data for the node to be stored in the first system file, the first system file being associated with the identifier of the node.

In some embodiments, the method may cause the performance data for the node to be transferred from hardware on a hubASIC of the node to the first system file.

The method may also configure a hub ASIC on each node to transfer its stored performance data to the first system file. In some embodiments, the method may create a plurality of first system files accessible in user space. Each first system file may correspond to a distinct node in the high performance computing system. The method may configure each hubASIC in the high performance computing system to transfer its stored performance data to the first system file corresponding to its node.

In various embodiments, the method retrieving the performance data in the first system file using a file read command.

Illustrative embodiments of the invention are implemented as a computer program product having a computer usable medium with computer readable program code thereon. A computer system may read and utilize the computer readable code in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a logical view of an HPC system in accordance with one embodiment of the present invention.

FIG. 2 schematically shows a physical view of the HPC system of FIG. 1.

FIG. 3 schematically shows details of a blade chassis of the HPC system of FIG. 1.

FIG. 4 is a flow diagram of an exemplary method of providing performance data for nodes in a high performance computing system.

### DESCRIPTION OF ILLUSTRATIVE EMBODIMENTS

In illustrative embodiments, the present application is directed to providing performance data of nodes in a high performance computing system via system files that are accessible in user space. From a command line interface, a user may issue a command for a node to provide its performance data. Alternatively, a script may issue the command. In response, the node transfers its performance data to a system file accessible in user space, which the user or other applications may access. Details of illustrative embodiments are discussed below.

### System Architecture

FIG. 1 schematically shows a logical view of an exemplary high-performance computing system 100 that may be used with illustrative embodiments of the present invention. Specifically, as known by those in the art, a “high-performance computing system,” or “HPC system,” is a computing system having a plurality of modular computing resources that are tightly coupled using hardware interconnects, so that processors may access remote data directly using a common memory address space.

The HPC system 100 includes a number of computing partitions 120, 130, 140, 150, 160, 170 for providing computational resources, and a system console 110 for managing the plurality of partitions 120-170. A “computing partition” (or “partition”) in an HPC system is an administrative allocation of computational resources that runs a single operating system instance and has a common memory address space. Partitions 120-170 may communicate with the system console 110 using a logical communication network 180. A system user, such as a scientist or engineer who desires to perform a calculation, may request computational resources from a system operator, who uses the system console 110 to allocate and manage those resources. The HPC system 100 may have any number of computing partitions that are administratively assigned as described in more detail below, and often has only one partition that encompasses all of the available computing resources. Accordingly, this figure should not be seen as limiting the scope of the invention.

Each computing partition, such as partition 160, may be viewed logically as if it were a single computing device, akin to a desktop computer. Thus, the partition 160 may execute software, including a single operating system (“OS”) instance 191 that uses a basic input/output system (“BIOS”) 192 as these are used together in the art, and application software 193 for one or more system users.

Accordingly, as also shown in FIG. 1, a computing partition has various hardware allocated to it by a system operator, including one or more microprocessors 194, volatile memory 195, non-volatile storage 196, and input and output (“I/O”) devices 197 (e.g., network ports, video display devices, keyboards, and the like). However, in HPC systems like the embodiment in FIG. 1, each computing partition has a great deal more processing power and memory than a typical desktop computer. The OS software may include, for example, a Windows® operating system by Microsoft Corporation of Redmond, Wash., or a Linux operating system. Moreover, although the BIOS may be provided as firmware by a hardware manufacturer, such as Intel Corporation of Santa Clara, Calif., it is typically customized according to the needs of the HPC system designer to support high-performance computing, as described below in more detail.

As part of its system management role, the system console 110 acts as an interface between the computing capabilities of the computing partitions 120-170 and the system operator or other computing systems. To that end, the system console 110 issues commands to the HPC system hardware and software on behalf of the system operator that permit, among other things: 1) booting the hardware, 2) dividing the system computing resources into computing partitions, 3) initializing the partitions, 4) monitoring the health of each partition and any hardware or software errors generated therein, 5) distributing operating systems and application software to the various partitions, 6) causing the operating systems and software to execute, 7) backing up the state of the partition or software therein, 8) shutting down application software, and 9) shutting down a computing partition or the entire HPC system 100. These particular functions are described in more detail in the section below entitled “System Management Functions.”

FIG. 2 schematically shows a physical view of a high performance computing system 100 in accordance with the embodiment of FIG. 1. The hardware that comprises the HPC system 100 of FIG. 1 is surrounded by the dashed line. The HPC system 100 is connected to a customer data network 210 to facilitate customer access.

The HPC system 100 includes a system management node (“SMN”) 220 that performs the functions of the system console 110. The management node 220 may be implemented as a desktop computer, a server computer, or other similar computing device, provided either by the customer or the HPC system designer, and includes software necessary to control the HPC system 100 (i.e., the system console software).

The HPC system 100 is accessible using the data network 210, which, among other things, may be a customer local area network (“LAN”), a virtual private network (“VPN”), or the Internet. Any of these networks may permit a number of users to access the HPC system resources remotely and/or simultaneously. For example, the management node 220 may be accessed by a customer computer 230 by way of remote login using tools known in the art such as Windows® Remote Desktop Services or the Unix secure shell. If the customer is so inclined, access to the HPC system 100 may be provided to a remote computer 240. The remote computer 240 may access the HPC system by way of a login to the management node 220 as just described, or using a gateway or proxy system as is known to persons in the art.

The hardware computing resources of the HPC system 100 (e.g., the processors, memory, non-volatile storage, and I/O devices shown in FIG. 1) are provided collectively by one or more “blade chassis,” such as blade chassis 268, 268′, 268″, 268′″; shown in FIG. 2, that are managed and allocated into computing partitions. A blade chassis is an electronic chassis that is configured to house, power, and provide high-speed data communications between a plurality of stackable, modular electronic circuit boards called “blades.” Each blade includes enough computing hardware to act as a standalone computing server. The modular design of a blade chassis permits the blades to be connected to power and data lines with a minimum of cabling and vertical space.

Accordingly, each blade chassis, for example blade chassis 252, has a chassis management controller 260 (also referred to as a “chassis controller” or “CMC”) for managing system functions in the blade chassis 252, and a number of blades 262, 264, 266 for providing computing resources. Each blade, for example blade 262, contributes its hardware computing resources to the collective total resources of the HPC system 100. The system management node 220 manages the hardware computing resources of the entire HPC system 100 using the chassis controllers, such as chassis controller 260, while each chassis controller in turn manages the resources for just the blades in its blade chassis. The chassis controller 260 is physically and electrically coupled to the blades 262-266 inside the blade chassis 252 by means of a local management bus 268, described below in more detail. The hardware in the other blade chassis 254-258 is similarly configured.

The chassis controllers communicate with each other using a management connection 270. The management connection 270 may be a high-speed LAN, for example, running an Ethernet communication protocol, or other data bus. By contrast, the blades communicate with each other using a computing connection 280. To that end, the computing connection 280 illustratively has a high-bandwidth, low-latency system interconnect, such as NumaLink, developed by Silicon Graphics International Corp. of Fremont, Calif.

The chassis controller 260 provides system hardware management functions to the rest of the HPC system. For example, the chassis controller 260 may receive a system boot command from the SMN 220, and respond by issuing boot commands to each of the blades 262-266 using the local management bus 268. Similarly, the chassis controller 260 may receive hardware error data from one or more of the blades 262-266 and store this information for later analysis in combination with error data stored by the other chassis controllers. In some embodiments, such as that shown in FIG. 2, the SMN 220 or a customer computer 230 are provided access to a single, master chassis controller 260 that processes system management commands to control the HPC system 100 and forwards these commands to the other chassis controllers. In other embodiments, however, an SMN 220 is coupled directly to the management connection 270 and issues commands to each chassis controller individually. Persons having ordinary skill in the art may contemplate variations of these designs that permit the same type of functionality, but for clarity only these designs are presented.

The blade chassis 252, its blades 262-266, and the local management bus 268 may be provided as known in the art. However, the chassis controller 260 may be implemented using hardware, firmware, or software provided by the HPC system designer. Each blade provides the HPC system 100 with some quantity of microprocessors, volatile memory, non-volatile storage, and I/O devices that are known in the art of standalone computer servers. However, each blade also has hardware, firmware, and/or software to allow these computing resources to be grouped together and treated collectively as computing partitions, as described below in more detail in the section entitled “System Management Functions.”

While FIG. 2 shows an HPC system 100 having four chassis and three blades in each chassis, it should be appreciated that these figures do not limit the scope of the invention. An HPC system may have dozens of chassis and hundreds of blades; indeed, HPC systems often are desired because they provide very large quantities of tightly-coupled computing resources.

FIG. 3 schematically shows a single blade chassis 252 in more detail. In this figure, parts not relevant to the immediate description have been omitted. The chassis controller 260 is shown with its connections to the system management node 220 and to the management connection 270. The chassis controller 260 may be provided with a chassis data store 302 for storing chassis management data. In some embodiments, the chassis data store 302 is volatile random access memory (“RAM”), in which case data in the chassis data store 302 are accessible by the SMN 220 so long as power is applied to the blade chassis 252, even if one or more of the computing partitions has failed (e.g., due to an OS crash) or a blade has malfunctioned. In other embodiments, the chassis data store 302 is non-volatile storage such as a hard disk drive (“HDD”) or a solid state drive (“SSD”). In these embodiments, data in the chassis data store 302 are accessible after the HPC system has been powered down and rebooted.

FIG. 3 shows relevant portions of specific implementations of the blades 262 and 264 for discussion purposes. The blade 262 includes a blade management controller 310 (also called a “blade controller” or “BMC”) that executes system management functions at a blade level, in a manner analogous to the functions performed by the chassis controller at the chassis level. For more detail on the operations of the chassis controller and blade controller, see the section entitled “System Management Functions” below. The blade controller 310 may be implemented as custom hardware, designed by the HPC system designer to permit communication with the chassis controller 260. In addition, the blade controller 310 may have its own RAM 311 to carry out its management functions. The chassis controller 260 communicates with the blade controller of each blade using the local management bus 268, as shown in FIG. 3 and the previous figures.

The blade 262 also includes one or more processors 320, 322 that are connected to RAM 324, 326. Blade 262 may be alternately configured so that multiple processors may access a common set of RAM on a single bus, as is known in the art. It should also be appreciated that processors 320, 322 may include any number of central processing units (“CPUs”) or cores, as is known in the art. The processors 320, 322 in the blade 262 are connected to other items, such as a data bus that communicates with I/O devices 332, a data bus that communicates with non-volatile storage 334, and other buses commonly found in standalone computing systems. (For clarity, FIG. 3 shows only the connections from processor 320 to these other devices.) The processors 320, 322 may be, for example, Intel© Core™ processors manufactured by Intel Corporation. The I/O bus may be, for example, a PCI or PCI Express (“PCIe”) bus. The storage bus may be, for example, a SATA, SCSI, or Fibre Channel bus. It will be appreciated that other bus standards, processor types, and processor manufacturers may be used in accordance with illustrative embodiments of the present invention.

Each blade (e.g., the blades 262 and 264) each include an application-specific integrated circuit 340 (also referred to as an “ASIC”, “hub chip”, or “hub ASIC”) that controls much of its functionality. More specifically, to logically connect the processors 320, 322, RAM 324, 326, and other devices 332, 334 together to form a managed, multi-processor, coherently-shared distributed-memory HPC system, the processors 320, 322 are electrically connected to the hub ASIC 340. The hub ASIC 340 thus provides an interface between the HPC system management functions generated by the SMN 220, chassis controller 260, and blade controller 310, and the computing resources of the blade 262.

In this connection, the hub ASIC 340 connects with the blade controller 310 by way of a field-programmable gate array (“FPGA”) 342 or similar programmable device for passing signals between integrated circuits. In particular, signals are generated on output pins of the blade controller 310, in response to commands issued by the chassis controller 260. These signals are translated by the FPGA 342 into commands for certain input pins of the hub ASIC 340, and vice versa. For example, a “power on” signal received by the blade controller 310 from the chassis controller 260 requires, among other things, providing a “power on” voltage to a certain pin on the hub ASIC 340; the FPGA 342 facilitates this task.

The field-programmable nature of the FPGA 342 permits the interface between the blade controller 310 and ASIC 340 to be reprogrammable after manufacturing. Thus, for example, the blade controller 310 and ASIC 340 may be designed to have certain generic functions, and the FPGA 342 may be used advantageously to program the use of those functions in an application-specific way. The communications interface between the blade controller 310 and ASIC 340 also may be updated if a hardware design error is discovered in either module, permitting a quick system repair without requiring new hardware to be fabricated.

Also in connection with its role as the interface between computing resources and system management, the hub ASIC 340 is connected to the processors 320, 322 by way of a high-speed processor interconnect 344. In one embodiment, the processors 320, 322 are manufactured by Intel Corporation which provides the Intel® QuickPath Interconnect (“QPI”) for this purpose, and the hub ASIC 340 includes a module for communicating with the processors 320, 322 using QPI. Other embodiments may use other processor interconnect configurations.

The hub chip 340 in each blade also provides connections to other blades for high-bandwidth, low-latency data communications. Thus, the hub chip 340 includes a link 350 to the computing connection 280 that connects different blade chassis. This link 350 may be implemented using networking cables, for example. The hub ASIC 340 also includes connections to other blades in the same blade chassis 252. The hub ASIC 340 of blade 262 connects to the hub ASIC 340 of blade 264 by way of a chassis computing connection 352. The chassis computing connection 352 may be implemented as a data bus on a backplane of the blade chassis 252 rather than using networking cables, advantageously allowing the very high speed data communication between blades that is required for high-performance computing tasks. Data communication on both the inter-chassis computing connection 280 and the intra-chassis computing connection 352 may be implemented using the NumaLink protocol or a similar protocol.

### System Operation

System management commands generally propagate from the SMN 220, through the management connection 270 to the blade chassis (and their chassis controllers), then to the blades (and their blade controllers), and finally to the hub ASICS that implement the commands using the system computing hardware.

As a concrete example, consider the process of powering on an HPC system. In accordance with exemplary embodiments of the present invention, the HPC system 100 is powered when a system operator issues a “power on” command from the SMN 220. The SMN 220 propagates this command to each of the blade chassis 252-258 by way of their respective chassis controllers, such as chassis controller 260 in blade chassis 252. Each chassis controller, in turn, issues a “power on” command to each of the respective blades in its blade chassis by way of their respective blade controllers, such as blade controller 310 of blade 262. blade controller 310 issues a “power on” command to its corresponding hub chip 340 using the FPGA 342, which provides a signal on one of the pins of the hub chip 340 that allows it to initialize. Other commands propagate similarly.

Once the HPC system is powered on, its computing resources may be divided into computing partitions. The quantity of computing resources that are allocated to each computing partition is an administrative decision. For example, a customer may have a number of projects to complete, and each project is projected to require a certain amount of computing resources. Different projects may require different proportions of processing power, memory, and I/O device usage, and different blades may have different quantities of the resources installed. The HPC system administrator takes these considerations into account when partitioning the computing resources of the HPC system 100. Partitioning the computing resources may be accomplished by programming each blade's RAM 316. For example, the SMN 220 may issue appropriate blade programming commands after reading a system configuration file.

The collective hardware computing resources of the HPC system 100 may be divided into computing partitions according to any administrative need. Thus, for example, a single computing partition may include the computing resources of some or all of the blades of one blade chassis 252, all of the blades of multiple blade chassis 252 and 254, some of the blades of one blade chassis 252 and all of the blades of blade chassis 254, all of the computing resources of the entire HPC system 100, and other similar combinations. Hardware computing resources may be partitioned statically, in which case a reboot of the entire HPC system 100 is required to reallocate hardware. Alternatively and preferentially, hardware computing resources are partitioned dynamically while the HPC system 100 is powered on. In this way, unallocated resources may be assigned to a partition without interrupting the operation of other partitions.

It should be noted that once the HPC system 100 has been appropriately partitioned, each partition may be considered to act as a standalone computing system. Thus, two or more partitions may be combined to form a logical computing group inside the HPC system 100. Such grouping may be necessary if, for example, a particular computational task is allocated more processors or memory than a single operating system can control. For example, if a single operating system can control only 64 processors, but a particular computational task requires the combined power of 256 processors, then four partitions may be allocated to the task in such a group. This grouping may be accomplished using techniques known in the art, such as installing the same software on each computing partition and providing the partitions with a VPN.

Once at least one partition has been created, the partition may be booted and its computing resources initialized. Each computing partition, such as partition 160, may be viewed logically as having a single OS 191 and a single BIOS 192. As is known in the art, a BIOS is a collection of instructions that electrically probes and initializes the available hardware to a known state so that the OS can boot, and is typically provided in a firmware chip on each physical server. However, a single logical computing partition 160 may span several blades, or even several blade chassis. A blade may be referred to as a “computing node” or simply a “node” to emphasize its allocation to a particular partition. In some embodiments, a blade may include more than one “node.”

Booting a partition in accordance with an embodiment of the invention requires a number of modifications to be made a blade chassis that is purchased from stock. In particular, the BIOS in each blade is modified to determine other hardware resources in the same computing partition, not just those in the same blade or blade chassis. After a boot command has been issued by the SMN 220, the hub ASIC 340 eventually provides an appropriate signal to the processor 320 to begin the boot process using BIOS instructions. The BIOS instructions, in turn, obtain partition information from the hub ASIC 340 such as: an identification (node) number in the partition, a node interconnection topology, a list of devices that are present in other nodes in the partition, a master clock signal used by all nodes in the partition, and so on. Armed with this information, the processor 320 may take whatever steps are required to initialize the blade 262, including 1) non-HPC-specific steps such as initializing I/O devices 332 and non-volatile storage 334, and 2) also HPC-specific steps such as synchronizing a local hardware clock to a master clock signal, initializing HPC-specialized hardware in a given node, managing a memory directory that includes information about which other nodes in the partition have accessed its RAM, and preparing a partition-wide physical memory map.

At this point, each physical BIOS has its own view of the partition, and all of the computing resources in each node are prepared for the OS to load. The BIOS then reads the OS image and executes it, in accordance with techniques known in the art of multiprocessor systems. The BIOS presents to the OS a view of the partition hardware as if it were all present in a single, very large computing device, even if the hardware itself is scattered among multiple blade chassis and blades. In this way, a single OS instance spreads itself across some, or preferably all, of the blade chassis and blades that are assigned to its partition. Different operating systems may be installed on the various partitions. If an OS image is not present, for example immediately after a partition is created, the OS image may be installed using processes known in the art before the partition boots.

Once the OS is safely executing, its partition may be operated as a single logical computing device. Software for carrying out desired computations may be installed to the various partitions by the HPC system operator. Users may then log into the SMN 220. Access to their respective partitions from the SMN 220 may be controlled using volume mounting and directory permissions based on login credentials, for example. The system operator may monitor the health of each partition, and take remedial steps when a hardware or software error is detected. The current state of long-running application programs may be saved to non-volatile storage, either periodically or on the command of the system operator or application user, to guard against losing work in the event of a system or application crash. The system operator or a system user may issue a command to shut down application software. Other operations of an HPC partition may be known to a person having ordinary skill in the art. When administratively required, the system operator may shut down a computing partition entirely, reallocate or deallocate computing resources in a partition, or power down the entire HPC system 100.

### Providing Access to Performance Data for Nodes in a High Performance Computing Environment

As partitions in the HPC system 100 execute projects from customers, each hub ASIC 340 collects performance data about its node. By analyzing the data, system administrators may identify and address performance related problems in the HPC system 100.

Previously, to access the data stored by the hub ASIC 340, an administrator would run a software performance application that interfaces with software operating the hub ASIC 340. In response to an application request for performance data, the software executes a call to the hub ASIC 340 driver. In response, the hub ASIC 340 transfers the performance data to a device file, and the device associated with the file outputs the data. The administrator obtains the performance data by, for example, retrieving the printed text that a printer outputted when the performance data was written to its device file. In this manner, the administrator both requests and accesses the performance data indirectly.

In contrast, illustrative embodiments described herein enable administrators and other HPC system 100 users to request and obtain the performance data of nodes more directly. The embodiments also enable users to specify the nodes for which performance data is being sought. To make a request, a user may issue a command from a command-line interface or an executing script issues the command. The command writes the identifier for the node of interest into a system file that has been configured for communication with one or more hub ASICs' 340 drivers. When the identifier for a node is written into this system file, the identifier in the system file is transferred from userspace to the kernel driver. Such transfer triggers the driver in kernel space for the hub ASIC 340 on the identified node. As a result, the hub ASIC 340 driver in kernel space transfers the hub ASIC's 340 stored performance data to an allocated portion of kernel memory. This portion of kernel memory is accessible in userspace via another system file such that the user or applications may access its performance data using simple system file read commands.

In operation, an administrator for the HPC system 100 installs one or more drivers in kernel space for the hub ASICs 340. The administrator may install the driver(s) according to any known method of installation. In some embodiments, the administrator uses a line command from the system's 100 command line interface. For example, the line command may be:

insmod dash.ko

When the driver is installed, the driver creates a system file that is configured for communication with the driver (also referred to as a “system command file”). This system command file is accessible in kernel space. The driver receives requests through this system command file. Altering the system command file transfers the value(s) in the file from userspace to the kernel drive, thereby triggering the driver to operate the hub ASIC 340. In some embodiments, the system command file accepts many types of requests, and the operation of the hub ASIC 340 depends on the type of request received. In some embodiments, the system command file only receives requests for performance data of the node. The driver creates other system files that are also configured for communication with the hub ASIC 340 driver. Each system file is configured to receive a different type of request, and writing to the respective system files transfers the value(s) in those files from userspace to the kernel driver to trigger the driver for different operations of the hub ASIC 340.

In some embodiments, one system command file is created for communicating with all of the hub ASIC 340 drivers in the system 100 or in a partition. Thus, writing to the system command file triggers all of the hub ASIC 340 drivers, but only the driver for whom the request is directed will operate its hub ASIC 340. In other embodiments, each driver for a hub ASIC 340 creates a system command file configured solely for its communication. An exemplary name for a system command file is:

/sys/device/system/dashboard/dashboard0/dump_nasid

The driver also allocates a portion of kernel memory for storing the performance data of its node. In many embodiments, the driver creates another system file configured for accessing the allocated portion of kernel memory (also referred to as a “system data file”). This system data file is accessible in user space. In various embodiments, the performance data in kernel memory is accessible via the system data file using system file read commands, such as read commands from the HPC system's 100 command line interface.

In some embodiments, the allocated portion of kernel memory receives performance data for all of the nodes and is accessible via a single system data file. In other embodiments, separate system data files are associated with different portions of kernel memory, each portion receiving performance data for a different node. An exemplary name for a system data file is:

/proc/dashboard

Further, in some embodiments, the driver configures hardware on the hub ASIC(s) 340 to transfer its stored performance data to the portion of kernel memory that receives data from all of the partition's nodes. In other embodiments, the driver configures the hardware to transfer its data to the portion of kernel memory specific to the hub ASIC's 340 node. Further, the driver configures the manner in which the data is output. For example, the driver may configure the order in which the hardware outputs performance data. Thus, performance data from any given hub ASIC 340 may be ordered in one or more portions of kernel memory in the same manner. In another example, the driver may configure the format in which hardware outputs data, thereby attain uniform organization of performance data. With such known parameters for the output data, a user or script may parse or extract desired data.

As the HPC system 100 executes projects for customers, the hub ASICs 340 collects and stores performance data about their respective nodes. As the hub ASIC 340 collects more data, the hub ASIC 340 retrieves the stored data, updates the data according to the newly collected data, and stores the new values. In some embodiments, a hub ASIC 340 stores the data in its own hardware. For example, the hub ASIC 340 may store the data in its hardware registers. In further embodiments, the hub ASIC 340 may store the performance data in a memory internal to the hub ASIC 340. In other embodiments, the hub ASIC 340 stores the data in a memory on the node.

A user or script may request performance data for a node in a number of ways. In some embodiments, a user may issue a command in a command-line interface. For example, the user may first log into the HPC system 100. From the system's 100 command line interface, the user may input a command for a particular node to provide its performance data. An exemplary command may conform to the following format:

Echo [node identifier]>[system file name]

For example, the following command could be used to request performance data for node “2”:

echo 2>/sys/device/system/dashboard/dashboard0/dump_nasid

This command writes the node identifier into the system command file, e.g., the identifier “2” is written into the file sys/device/system/dashboard/dashboard0/dump_nasid.

In various embodiments, the HPC system 100 may execute a script to request performance data, from one or more nodes. The user may set parameters according to which the script will request the data. In some examples, the parameters indicate the node(s) for which the script will request performance data (e.g., the parameters include the identifiers of the nodes). In further examples, the parameters indicate the periodicity for which such requests shall be made such that a script requests data each time an interval of time corresponding to the periodicity elapses.

The script requests performance data according to the user-specified parameters. Each time the script makes a request, the script generates an interrupt and writes the node identifier into the system command file. In some embodiments, the user configures a script to request performance data for node 2 every 500 ms and performance data for node 4 every 1000 ms. The script may execute a timer or monitor the value of a timer. Each time 500 ms elapses, the script generates an interrupt and writes the identifier “2” into the system command file for node 2. The script may reset a timer and continue generating interrupts and resetting whenever 500 ms elapses. Likewise, each time 1000 ms elapses, the script generates an interrupt and writes the identifier “4” into the system command file for node 4. The script may reset a timer, if applicable.

Writing a node identifier into the system command file transfers the value(s) in the system command file from user space to the kernel driver, thereby triggering the driver for the identified node's hub ASIC 340. The hub ASIC 340 driver causes the hub ASIC 340 to transfer its performance data to the portion of kernel memory. In some embodiments, the hub ASIC 340 transfers data in its hardware registers to kernel memory. In other embodiments, the hub ASIC 340 causes a memory in the hub ASIC 340 or a memory on the node to transfer copies of its stored performance data to kernel memory. In various embodiments, transferring the performance data resets the values in hardware or memory. The reset enables performance data for the node to be collected and provided at regular intervals, if requests are written to the system command files in such a manner.

When the hub ASIC 340 writes to the kernel memory, the hub ASIC 340 may append its contents. In some embodiments, the hub ASIC 340 may overwrite the kernel memory's contents.

Because the system data file is accessible in user space, the user may use the system data file to access the performance data using system file read commands. Likewise, an application or a script may also access the data using system file read commands. The hub ASIC 340 driver may map the system data file to the portion of kernel memory, where the performance data has been transferred.

In some embodiments, from the system's 100 command line interface, the user may input a command for a particular node to provide its performance data. An exemplary command may conform to the following format:

cp [system data file name] [output file name]

For example, a user may issue the following command to read the performance data in kernel memory, or to transfer contents of the kernel memory to another file that is in user space:

cp/proc/dashboard/tmp/dash.out

In various embodiments, a user may configure the same scripts that request performance data from nodes to also read performance data. For example, if a user has configured a script to request data at a specified periodicity, the user may also configure the script to read the corresponding portion of kernel memory with the same periodicity. In this manner, the script may obtain performance data for one or more nodes at predetermined intervals. In many embodiments, the script may analyze the performance data to detect patterns, or changes, in the data. Such patterns and/or changes may be used to identify performance issues for the HPC system 100.

FIG. 4 is a flow diagram of an exemplary method of providing performance data for nodes in a high performance computing system. The method includes creating a system file for communicating with a node driver (step 405). In some embodiments, the system file is created when the node driver is installed. In some embodiments, the system file is configured for communication with the node driver. The file may be configured for receiving requests to operate the node driver.

The method includes receiving a request for performance data for a node (step 410). A user may issue a command from a command line interface that writes a node identifier to the system file. In some embodiments, a script generates an interrupt according to its configured parameters and writes the node identifier to the file. The method includes storing an identifier of the node in the system file, triggering the node driver (step 415). The method includes storing the performance data for the node in kernel memory (step 420). In some embodiments, the node driver transfers its stored performance data to a portion of kernel memory. The node driver may transfer data stores in its hardware registers. In some embodiments, the node driver may transfer data stored in memory on a hub ASIC 340 or stored elsewhere on the node.

The disclosed apparatus and methods may be implemented as a computer program product for use with a computer system. Such implementation may include a series of computer instructions fixed either on a tangible medium, such as a computer readable medium (e.g., a diskette, CD-ROM, ROM, or fixed disk). The series of computer instructions can embody all or part of the functionality is previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a tangible removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Of course, some embodiments of the invention may be implemented as a combination of both software (e.g., a computer program product) and hardware. Still other embodiments of the invention are implemented as entirely hardware, or entirely software. The embodiments of the invention described above are intended to be merely exemplary; numerous variations and modifications will be apparent to those skilled in the art. All such variations and modifications are intended to be within the scope of the present invention as defined in any appended claims.

Although the above discussion discloses various exemplary embodiments of the invention, it should be apparent that those skilled in the art can make various modifications that will achieve some of the advantages of the invention without departing from the true scope of the invention.

What is claimed is:

1. A method of providing performance data for nodes in a high performance computing system, the method comprising:
receiving a request for performance data for a node in the high performance computing system; and
causing, by a driver in kernel space, the performance data for the node to be stored in kernel memory, the kernel memory being accessible in userspace via a first system file.

2. The method of claim 1, wherein receiving the request for the performance data for the node comprises:
receiving an identifier of the node in a second system file, the second system file configured to enable communication with the driver in kernel space.

3. The method of claim 2, further comprising:
transferring the identifier in the second system file from userspace to the driver in kernel space.

4. The method of claim 2, further comprising:
writing, by a script, the identifier of the node to the second system file.

5. The method of claim 2, further comprising:
writing the identifier of the node to the second system file in response to an instruction received through a command line interface.

6. The method of claim 2, wherein causing the performance data for the node to be stored includes:
causing the performance data for the node to be stored in a portion of the kernel memory, the portion of the kernel memory being associated with the identifier of the node.

7. The method of claim 1, wherein causing the performance data for the node to be stored includes:
causing the performance data for the node to be transferred from hardware on a hubASIC of the node to the kernel memory.

8. The method of claim 1, further comprising:
configuring a hub ASIC on each node to transfer its stored performance data to the kernel memory.

9. The method of claim 1, further comprising:
creating a plurality of first system files accessible in user space, each first system file corresponding to a distinct node in the high performance computing system; and
configuring each hubASIC in the high performance computing system to transfer its stored performance data to a distinct portion of the kernel memory associated with the first system file corresponding to its node.

10. The method of claim 1, further comprising:
retrieving the performance data in kernel memory associated with the first system file using a file read command.
